(19) United States
(12) Patent Application Publication
(10) Pub. No.: US 2017/0299091 A1
(43) Pub. Date: Oct. 19, 2017

(54) MULTI-LINE CONDUIT ASSEMBLIES

(71) Applicant: STM Venture Partners Inc., Concord (CA)

(72) Inventors: Antonio GALLUCCI, King City (CA); Sergio De Zen, Vaughan (CA); Mauro Tonon, Caledon (CA)

(21) Appl. No.: 15/491,244

(22) Filed: Apr. 19, 2017

Related U.S. Application Data
(60) Provisional application No. 62/458,240, filed on Feb. 13, 2017.
(60) Provisional application No. 62/324,526, filed on Apr. 19, 2016.

(51) Int. Cl. F16L 9/19

(52) U.S. Cl. CPC F16L 9/20

(57) ABSTRACT

In various embodiments, multi-conduit assemblies 100 comprise pluralities of individual or distinct conduits 101 joined by various forms of webs 110, sleeves 176, wraps 222, 212, and/or retainers 181. Assemblies 100 are useful for fluid, electrical, communications, and other applications.

### FIELD OF THE INVENTION

This application claims all benefit, including priority, of U.S. Provisional Patent Application Ser. No. 62/324,526, filed 19 Apr. 2016 and entitled Multi-Line Flexible Pipe, and of U.S. Provisional Patent Application Ser. No. 62/458,240, filed 13 Feb. 2017 and entitled Multi-Line Flexible Conduits, the entire contents of each of which are incorporated herein by this reference.

### FIELD OF THE INVENTION

The invention relates to pipes and other conduits. In particular, the invention relates to commonly-extruded or otherwise integrated multi-line conduits and conduit assemblies suitable for fluid, electrical, and other applications.

### BACKGROUND OF THE INVENTION

Builders, carpenters, plumbers, electricians, home-repair workers, and others are often faced with the necessity or desirability of installing conduits for the transfer of water, glycol and/or other heating and/or cooling fluids, hydraulic fluid, air, and other fluids; and for insulating, heating, cooling, guiding and containing electrical, fiber-optic, communications, control, and other wires, cables, etc.

In many cases, it can be necessary or desirable to install such conduits in pairs or other multiples. For example, it may be desirable to provide separate, parallel conduits for hot and cold water, electrical or fiber-optic lines, control lines or control cables, network and other communication cables, air conditioning supply and return lines, etc. Using known conduit products (e.g., individual rigid water pipes, electrical conduits, etc.), it is necessary to run such multi-conduit lines one-by-one, using individual conduits, which are separately formed and must be separately transported, handled, installed, and secured.

There is need for improvements in such conduit assemblies, and means for creating and installing them.

### SUMMARY OF THE INVENTION

In various aspects and embodiments, the invention provides commonly-extruded or otherwise joined or integrated multi-conduit pipes and other conduits, and methods of making, using, and installing them, and features or components thereof.

For example, in one aspect the invention provides multi-pipe or multi-conduit assemblies, each such assembly comprising a plurality of individual or distinct conduits, each pair of conduits optionally joined by one or more webs and/or retainers. Such multi-conduit pipes can be formed with particular advantage through the use of single, continuous extrusions, and can optionally be either or both of flexible and fluid tight. While in some embodiments multi-conduit pipes in accordance with the disclosure can be substantially rigid (e.g., not rollable or bendable without inelastic deformation), it has been found that the ability to roll and otherwise flex conduit assemblies, for example to store them or to pass them around obstructions in walls and other structures, turn corners, etc., can provide particular advantage. To the inventors' knowledge, no such conduit assemblies have appeared in the art.

In further embodiments, multi-conduit assemblies in accordance with the invention are formed though the use of sleeves or wraps, whereby individual conduits can be inserted into corresponding individual sleeves, the sleeves being joined by webs.

Alternatively, or in addition, multi-conduit assemblies in accordance with the invention can effectively be placed in sleeves through the use of heat-activated, adhesive, elastic, or other forms of wraps formed from sheet products, so that continuous sleeves of desired length may be provided, optionally with webs between adjacent conduits.

In some further embodiments, multi-conduit assemblies in accordance with the invention are formed through the use of clips and/or other retainers which support pluralities of individual conduits in desired juxtapositions with respect to one another. Optionally such retainers can be closeable, permanently or releasably, and/or they can be used in combination with sheets or ribbons of flexible wrapping material such as plastic sheets or various forms of tape, in order to join them in desired relations to one another, optionally forming web(s) between adjacent conduits.

Advantageously, multi-conduit assemblies in accordance with the invention may comprise two, three, or any other desired number of separate (i.e., distinct) conduits. Conduits of a multi-conduit assembly in accordance with the invention may be of any desired or required size(s), and individual conduits of a multi-conduit assembly may be of the same or different sizes, and fabricated using the same and/or other materials. Pairs or other multiples of conduits can be joined by any desired number of webs, depending upon the purpose(s) of the assembly(ies), the intended or desired installation method(s), the materials of which the pipe(s) are to be fabricated, the materials the conduits(s) are intended to transfer or otherwise contain, the environment(s) in which the pipe(s) are to be installed, etc.

A further and particularly advantageous feature offered by various embodiments of the invention is the option of joining individual pairs of conduits by means of scored, frangible, or otherwise separable webs, so that the conduits may be separated from one another and used separately, preferably without compromising their utility—for example, without compromising their fluid-tight integrity. For example, various forms of perforation(s) may be provided, such that an installer wishing to install a smaller number of conduits than that provided in a webbed multi-conduit assembly, or to separate one or more conduits from one or more other conduits over all or any part(s) of a conduit's run, may tear, cut, or otherwise break or separate the supporting web with greater ease and less resultant damage to the conduit(s) than if the web were solid.

As will be understood by those skilled in the relevant arts, once they have been made familiar with this disclosure, pipes and other conduits, sleeves, webs, retainers, clips, and/or other components in accordance with the invention may be fabricated using any material(s) and/or combination(s) of materials suitable for their intended purpose(s). Such factors can, for example, include the intended purpose(s) and geometry(ies) of the conduit(s), the intended or desired methods) to be used in installing the conduit(s), the absolute or relative availability of desirable materials, the material(s) the conduits are intended to transfer or otherwise contain, the environment(s) in which the conduits(s) are to be installed and used, etc. Non-limiting examples include polymers such as PEX, metals, including a wide range of metal alloys, carbon- and/or glass fibers and other composite materials, and concrete.

Advantageously, individual conduits, sets of conduits, and/or sections of conduits in multi-conduit pipes can, in accordance with the invention, be fabricated using different materials, or combinations of materials, in order to improve suitability for combined applications. For example, in an assembly intended to convey both fluids and electrical lines in a building installation, individual conduits intended for transfer of water, glycol, or other fluids in buildings may be fabricated using a first material, of combinations of materials; while conduits intended to insulate, protect, or otherwise contain electrical wiring may be fabricated using a second material, or combination of materials. As a further example, one or more sections of a multi-conduit pipe may be made of one or more first materials in a length of pipe intended to promote transfer of heat between a fluid contained by such length and its environment; and a one or more second materials in a length of pipe intended to reduce such heat transfer. Such composite pipes may be commonly extruded by, for example, using any of a variety of multi-material injection techniques.

Particular examples of materials suitable for use in implementing the invention include cross-linked polyethylene (sometimes abbreviated either “PEX” or “XLPE”), copper, steel, aluminum and other metals and alloys, carbon-and/or glass fibers and other composite materials, and concrete. PEX and other plastic materials provide flexible, fluid-tight, corrosion- and oxidation-resistant , and lightweight piping forms, which are readily rollable, frangible, and extrudible. Further examples include polyvinyl chloride (PVC) and polyethylene. Depending upon the desired application(s), any suitable plastics or polymers will serve. Particularly beneficial plastics include any of the bioplastics, and particularly those that are cornpostable or otherwise biodegradable.

In a further aspect, the invention provides methods of using multi-conduit pipes in accordance with the disclosure.

Thus it may be seen that the invention pertains to piping and other conduit systems in which multiple pipes are joined to one another along at least a portion of their lengths, in substantially parallel or other desired orientations or juxtapositions relative to one another, and provides a very wide number of options and variations of mechanisms for providing such systems.

### BRIEF DESCRIPTION OF THE DRAWINGS

Various aspects and embodiments of the invention are illustrated in the accompanying drawing, which is meant to be exemplary and not limiting.

FIG. 1 is a schematic isometric view of an intact, frangibly-webbed multi-conduit assembly in accordance with aspects and embodiments of the invention.

FIG. 2 is a schematic, isometric view of a partially-separated, frangibly-webbed multi-conduit assembly in accordance with various aspects and embodiments of the invention.

FIG. 3 is a schematic isometric view of a multi-conduit, multi-webbed assembly in accordance with aspects and embodiments of the invention.

FIG. 4 is a plan and cross-sectional view of a multi-conduit, multi-webbed assembly in accordance with aspects and embodiments of the invention.

FIGS. 5A-7B are schematic isometric and front views of embodiments of multi-conduit assemblies comprising sleeves or wraps, and devices for making multi-conduit assemblies, in accordance with various aspects and embodiments of the invention.

FIGS. 8A-14C are schematic, isometric views of embodiments of clips, retainers, and wraps useful for making multi-conduit assemblies in accordance with various aspects and embodiments of the invention.

FIG. 15 is a cross-sectional view of a conduit in accordance with various aspects and embodiments of the invention.

### DESCRIPTION OF EMBODIMENTS

Preferred embodiments of multi-conduit assemblies, and features thereof, according to the invention are described through reference to the drawings.

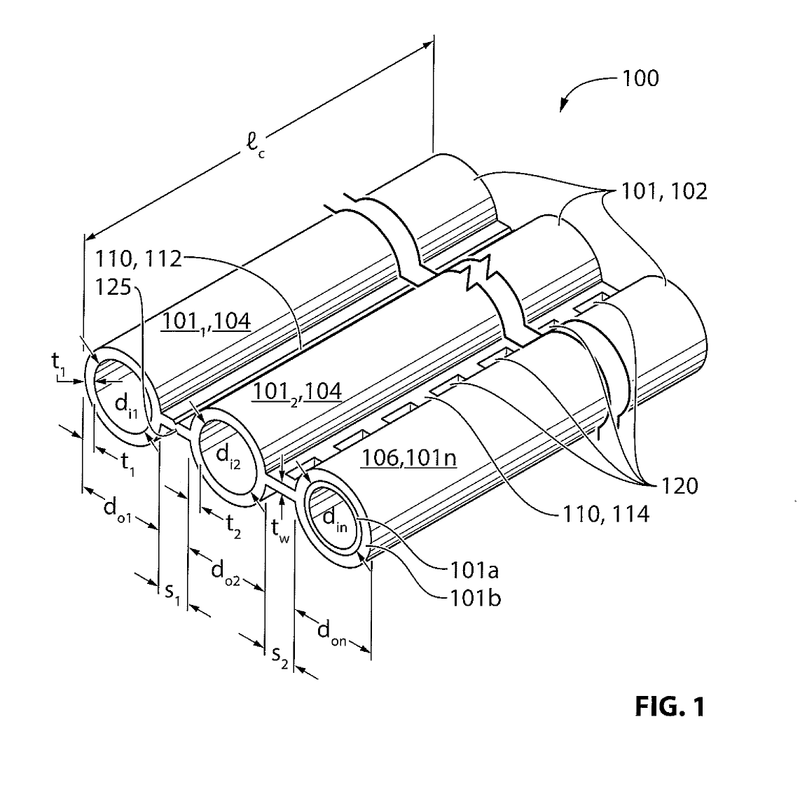

FIG. 1 is a schematic, isometric view of an intact, commonly-formed multi-conduit assembly 100 in accordance with various aspects and embodiments of the invention. In the embodiment shown, multi-conduit assembly 100 comprises a plurality (three) of distinct pipes or other conduits 101, the conduits joined in pairs along their lengths by single webs 110 in a substantially parallel orientation or juxtaposition. Conduits 101 may be of indefinite length(s) “l_{ci}”, which may be the same or different for individual conduits 101ᵢ₋ₙ; and may be of the same or various inner and/or outer diameters dᵢₙ, dₒₙ, depending upon the desired or intended application(s) of the assembly 100 and/or individual conduits 102, 106, 106, etc. Similarly, individual conduits may be any or all of circular, elliptical, square, rectangular, or of any other desired cross-sections, and such cross sections may vary along the lengths “l_{ci},” of the pipes/conduits.

Web(s) 110 may be of the same or differing lengths ‘l_{w},’ widths ‘s’, and thickness(es) t_{w} or t_{wi}, depending upon the desired or intended application(s) of the assembly 100 and/or individual conduits 102, 106, 106, etc.; and whether the individual webs 110 are solid (e.g., web 112) or perforated, etc. (e.g., web 114). Moreover widths “s” and thicknesses t_{w} can be uniform or varied along lengths “l” of the pipe and/or individual webs.

As will be understood by those skilled in the relevant arts, and as further explained above, conduits 101 and webs 110 may be formed by any suitable process(es), including for example extrusion, injection or other types of molding, vacuum forming and other forms of thermoforming or pressure forming, and similar processes. They may also be formed, as explained below, through the use of wraps, sleeves, clips, retainers, etc. As a specific example, a webbed multi-conduit assembly 100 such as that shown in FIG. 1 can be formed by a single continuous extrusion process.

Assemblies 100 and/or individual conduits 101 can be adapted for any desirable purpose(es), including for example the transfer of water or other liquids, air or other fluids, network and/or control cables, and/or the routing and protection of electrical and fiberoptic wiring or conduits. For example, an assembly 100, 170 such as that shown in FIG. 1 can comprise a thermally insulated first conduit 102 adapted for transfer of hot water; a non-insulated second conduit 104 adapted for transfer of cold water; an electrically-insulated third conduit 106 for containment and protection of electric wires; and a fourth conduit (not shown) for transfer of glycol, air, or other substance.

Thermal and/or electrical insulation of conduit(s) 101 can be provided by a wide variety of techniques, including molding, extrusion, or coating using suitably-insulating material(s), wrapping with suitably-insulated material, etc. For example, a flame-resistant, electrically-insulated conduit 101, 106 can be provided by co-extruding a single conduit comprising inner and outer layers 101a, 101b, as shown in FIG. 1. As an alternative example, such a conduit can be formed by inserting a first conduit 101a fabricated using material(s) comprising desired property(ies) to serve as a first, inner layer within a second conduit 101b fabricated using material(s) comprising other desired quality(ies) to serve as a second, outer layer. Alternatively, a conduit 101b of a suitably strong, lightweight material can be coated with material comprising suitably resistant and/or insulating properties. to form an inner layer 101a suitable for the desired purpose of the conduit 101. In any case, inner layer 101a can, for example, be formed of electrically-insulating, corrosion-resistant, or other material, and for example an cutler layer 101b can be formed of water- and/or flame resistant material. A wide variety of thermally- and electrically-insulating, and fire-resistant, plastics an are described at and can be acquired through, for example, http://www.professionalplastics.com and other sources.

Further examples of the advantageous use of conduits 101 having multiple layers 101a, 101b, etc., include the transfer of corrosive materials. Using for example a corrosion-resistant plastic or metal, an inner layer 101a can be provided to resist corrosion by interaction of transferred fluids and the inner wall(s) of the conduit layer 101a. For example, an inner layer 101 comprised of epoxy coating can help to maximize a service life of an assembly 100 adapted to transfer cooling fluids or other relatively corrosive substances.

Webs 110 can serve a variety of purposes, as desired. For example, in addition to providing secure and optionally flexible attachment between adjacent conduits and/or sets of conduits 101, they may be used to secure assemblies 100 to walls, studs, and other supporting structures. For example, nails, screws, and/or other fasteners can be driven through web(s) 110 at desired locations. In some embodiments, holes can be formed or otherwise provided in web(s) 110 in order to facilitate the use of such fasteners to secure assembly(ies) 100 to such supporting structures.

As shown for example in FIG. 3, adjacent conduits 101 of assembly(ies) 100 can be joined by any desired number of webs 110. In the embodiment shown in FIG. 3, conduits 102, 104 are joined by a plurality, two in number, 110a, 110b of webs 110.

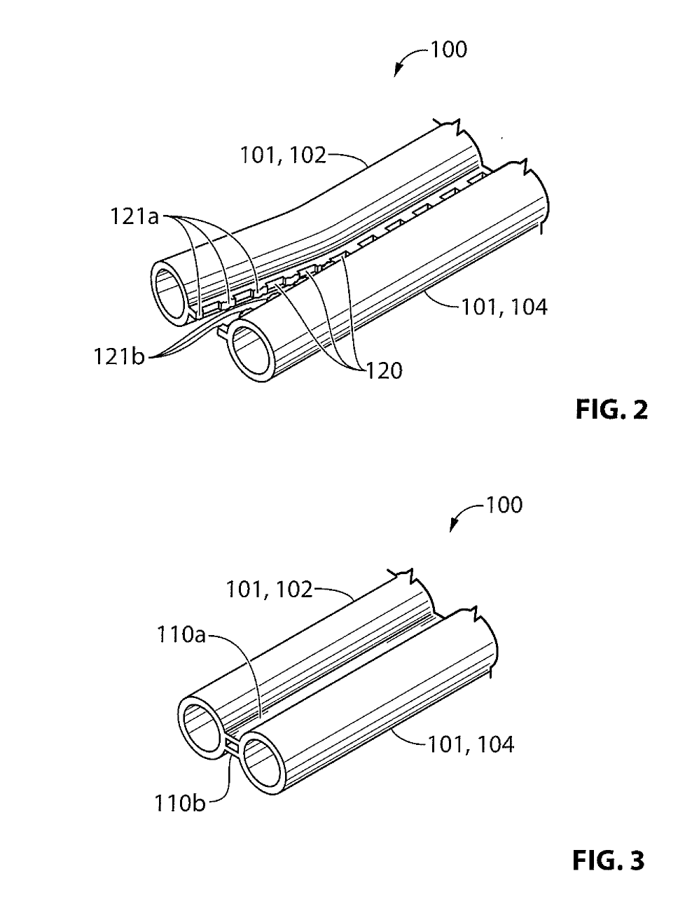

Optionally, web(s) 110 joining conduits 101 can be frangible (i.e., easily breakable), so that sets of conduits 101 can be more conveniently separated from one than otherwise might be the case. For example, as shown in FIGS. 1 and 2, a web 110, 114 can comprise a plurality of perforations 120, which may be circular, elliptical, rectangular, or of any other desired or convenient shape; alternatively, or in addition, such webs may be scored by means of one or more longitudinal scores 125, as also shown in FIG. 2. The use of such scores, perforations, or other devices to provide frangible webs 110 can enable one or more conduits 110 to be separated from one another by allowing frangible portions 121a, 121b to be broken away from each other, or by allowing a web 110 to be split along a scored portion 124, as shown for example in FIG. 2. Breaks along frangible portions 125, 120, 121, etc., can be created along all or any desired portions of lengths “l_{w}” along a web 110, so that individual conduits 101 can be installed entirely alone, or may split to go in different directions after travelling together for a portion of their lengths, or to go around obstacles such as structures, other pipes, etc along portion(s) of their lengths.

Optionally, and with significant advantage, frangible features 120, 121, 125 etc. can be configured to enable full or partial separation of conduit(s) 101 without compromising the structural integrity of separated portions. For example, the use of such frangible features can enable conduits 101 to be separated from one another without compromising their fluid-tight integrity.

As will be understood by those skilled in the relevant arts, frangible features 120, 125, etc., may be provided by any desired or otherwise suitable relative variations in structural strength and/or integrity along a web 110. For example, in addition to perforations and scored lines as described above, frangible portions of web(s) 100 can be provided by co-molding or extruding a desired portion of a web with a relatively weaker material than is used in fabrication of adjacent conduit(s) 101 and/or web(s) 110.

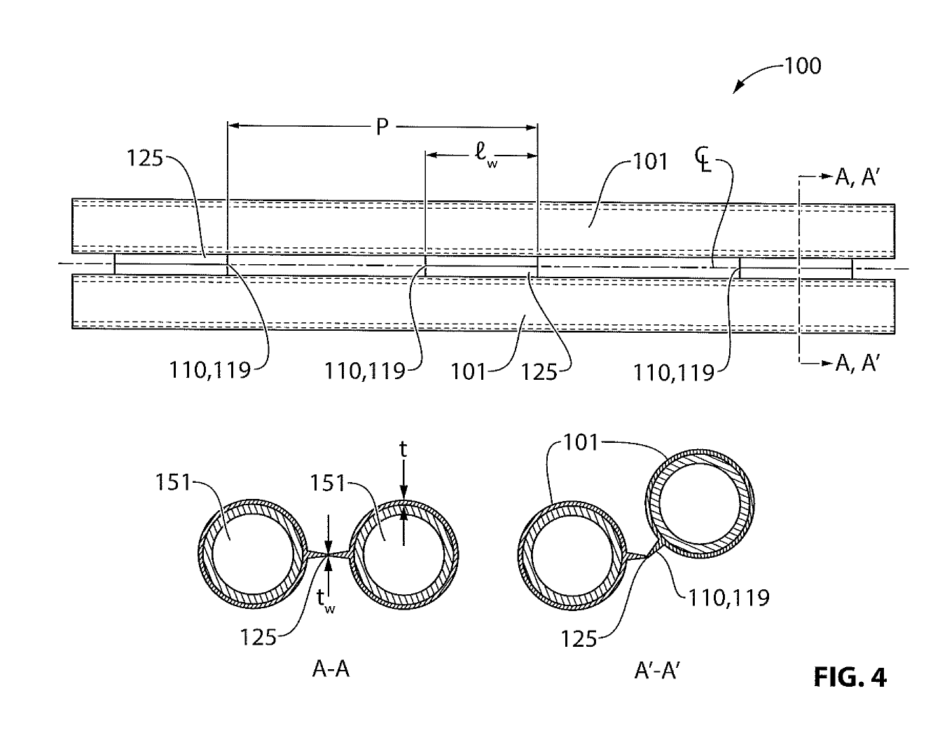

FIG. 4 shows an embodiment of a multi-conduit assembly 100 comprising intermittently-spaced webs 110. Such an embodiment can, for example, be efficiently formed by injection molding. In the embodiment shown, a pair of conduits 101 is joined by intermittent web segments 110, 119. Intermittent web segments 119 are, in this example, evenly spaced, but in various embodiments they may be set at any desired spacings. Moreover, as shown in Section A-A of FIG. 4, in the embodiment shown webs 110, 119 comprise variable thicknesses, which taper toward the centerline of the assembly 100. The use of such tapered web configurations can serve a variety of purposes. For example, such tapering can serve as score line, to facilitate separation of selected web segments 110, 119, or all of them. Alternatively, some or all of tapered webs 110, 119 can be used to bend all or any desired portion(s) of an assembly 101 as shown at Section A′-A′, for example to facilitate passage through holes in supporting structures, etc.

In the embodiment shown in FIG. 4, web segments 110, 119 are provided at a uniform pitch P, which can be of any suitable or otherwise desired length, which may, for example, be determined in whole or in part by an intended use of the assembly 100. As one example, in an embodiment of an assembly 100 intended for use in building construction, pitch P can be set to coincide with distance(s) between structural elements such as joists, studs, columns, vents, or beams. For example, in an embodiment suitable for use in constructing suburban dwellings, a pitch P of approximately sixteen inches (16″) may be selected, in order to facilitate support by or avoidance of joists and/or wall studs. Such an embodiment adapted for transfer of hot and cold potable water may, for example, have the dimensions shown in Section A-A.

As noted above, the embodiment shown in FIG. 4 is suitable for formation through the use of injection molding techniques. For example, in a vertical injection molding process, an assembly 100 can be molded in segments having lengths equal to or otherwise related to one or multiples of the desired pitch, P. For example, a pair of molds configured for formation of one or more pitch-length segments of the assembly 100 can be put in place, along with components adapted to form interior conduit spaces 151 of desired diameter by maintain a desired conduit thickness “t.” When the injected polymer, or other substance, has set to a desired degree, the mold can be opened, the completed assembly segment(s) advance, and the process repeated until an assembly 100 of desired length has been fabricated.

Thus, for example, the invention provides many varieties of multi-conduit assemblies 100, each assembly 100 comprising two, three, or any other desired numbers of distinct conduits 101. Any two or more of the plurality of conduits 101 can optionally be joined by one or more webs 110. Any or all of conduits 101, and/or various layers 101a, 101b, etc., can be any or all of fluid tight, electrically insulating, thermally insulating, corrosion resistant, fire-resistant, and/or exhibit any other desired properties under desired conditions. Such conduits 101 and webs 110 can be formed as a single, continuous extrusions, co-extrusions, or through any other desired or suitable manufacturing processes.

Multi-conduit assemblies 100 in accordance with various aspects of the invention can be implemented in a variety of ways.

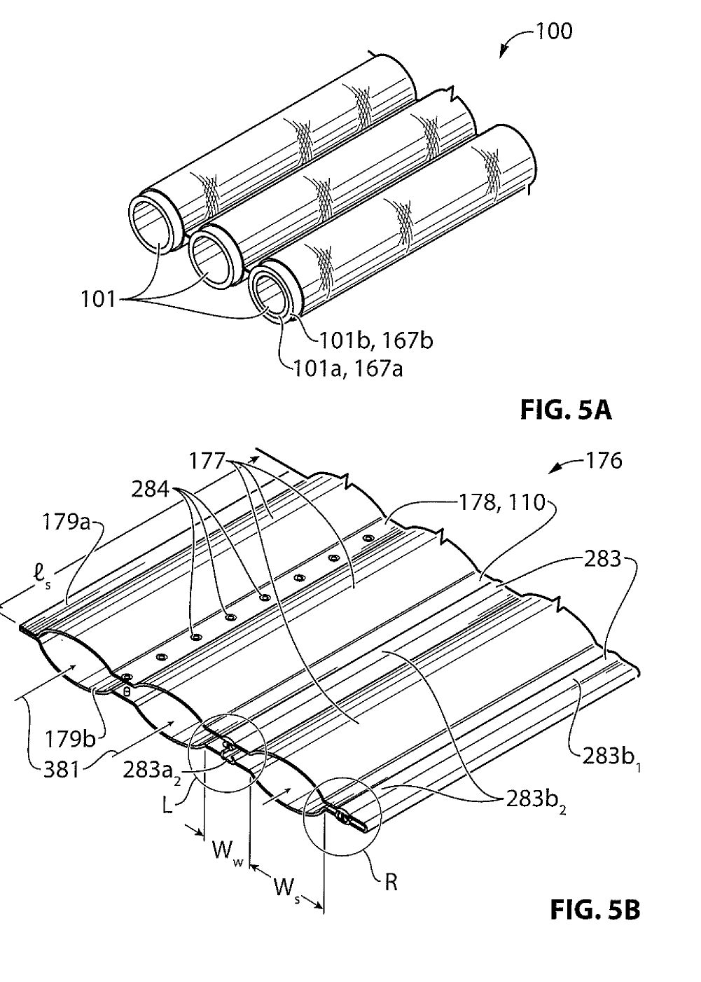

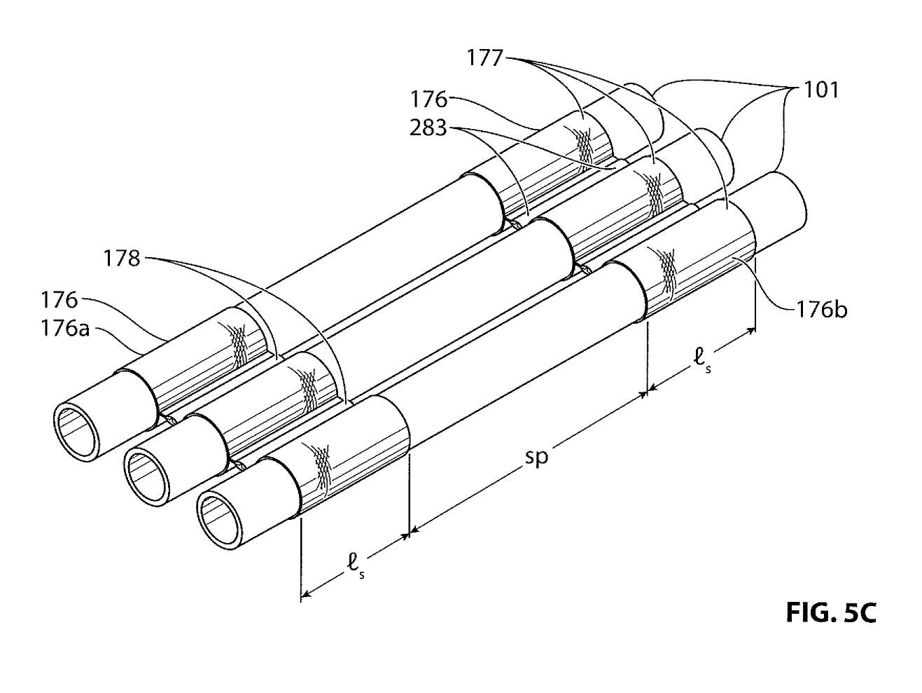

As shown for example in FIGS. 5A-5C, multi-conduit assemblies 100, 175 can be fabricated by inserting, in the direction of arrows 381, a plurality of conduits 101 into single or multi-layer sleeve retainers, tubes, or ‘socks’ 176 comprising pluralities of individual sleeve portions 177, each optionally joined to one or more adjacent individual sleeve portions 177 by by sleeve web(s) 178. Retainers 176 and individual sleeve portions 177 can be of any desired lengths lₛ; sleeves 177 can be of any desired width(s) wₛ; and webs 110, 170 can be of any desired width(s) w_{w}. Individual sleeve portions 177 can be sized to accommodate of engage engage outer surfaces of conduits 101 with any desired degree of tightness or slackness. For example individual sleeves 177 can be tight enough that the sleeve must be stretched in order to accept individual conduits 101 with an interference fit, for relatively fixed engagement and sure control over conduit location and juxtaposition with respect to other conduits 101. Moreover, retainers 176 can be long enough to cover substantially all of one or more conduits 101, or they can be short enough that several of them can be used at intervals along the length l_{c} of a conduit 101 or conduit assembly 100. For example, as shown in FIG. 5C, for a conduit assembly 100 of length greater than ten feet, a plurality of sleeves 177, each of lₛ of approximately 3 inches can be provided, and spaced at more or less equal intervals Sₚ of 2-3 feet.

As in the case of webs 110, sleeve webs 178 can serve a variety of purposes. For example, in addition to securing pluralities of adjacent conduits 101 to each other in pairs, they may be used to secure assemblies 100, 175 to walls, studs, and other supporting structures through the use of nails, screws or other fasteners. In some embodiments, holes can be formed or otherwise provided in web(s) 118 in order to facilitate the use of such fasteners to secure assembly(ies) 100 to such supporting structures; in other cases, nails, screws, and/or other fasteners can simply be driven through the web(s) 118 at desired intervals.

Multi-sleeve retainers 176 can be fabricated using any desired materials, including nylons or other synthetic materials, natural fabrics, etc. In many embodiments, such materials are flexible, so as for example to accommodate flexure in enclosed conduits 101. For example, such conduits can be flexible at room temperature, or within any desired temperature ranges, such as greater than or equal to about 50 degrees Fahrenheit below zero.

Depending upon the purpose(s) to which a multi-conduit assembly 175 is to be put, multi-sleeve retainer(s) 176 can be fabricated using fabrics having electrically insulating, thermally insulating, fire-resistant, or other desired properties, as well as suitable strength and desired flexibility. Such properties can be provided for all sleeves 177, or for individual sleeves or sets of sleeves 177.

For example, materials used to fabricate any one or more such sleeves can, alone or in conjunction with individual conduits 101, comprise any desired specific fireproof and/or electrical insulation ratings, or they can be non-rated. Retainers 176 and/or individual sleeves 177 can be relatively stiff and inflexible, e.g. by fabrication using glass fibers or other composites, or they can be relatively soft and collapsible, using organic or inorganic fabrics such as, for example, polyester, cotton, or other soft materials. Those skilled in the relevant arts will have no difficulty in identifying suitable fabrics, once they have been made familiar with this disclosure. A variety of fire-resistant fabrics, for example, are described at http://www.westex.com/fr-fabric-brands/.

Sleeves 177 can, in various embodiments, be of single or multiple layers. For example, as shown in FIG. 5B, a sleeve 177 (or entire retainer 176) can comprise an inner sleeve layer 179a of electrically insulating material, and an outer sleeve 179b comprising a desired fire-resistance rating. Additional sleeves 177 or layers 179 (not shown) can provide protection from abrasion, thermal insulation, etc.

As with other aspects and embodiments of the invention, assemblies 100, 175 comprising retainers 176 and/or sleeves 177 can comprise perforations 150, etc. (not shown in FIG. 5), in order to facilitate easy separation of individual conduits 101 and/or sets of conduits 101 from larger assemblies 100, 175.

Alternatively, or in addition, retainers 176 and/or individual sleeve portions 177 can comprise permanent and/or releasable fasteners, or fastening devices, between individual conduits 101, or between pairs or other sets of conduits 101. Such fasteners can for example be used for permanent and/or removable insertion and/or retention of individual conduit(s) 101, or sets of conduits 101, by sleeves 177; and/or for attachment and/or removal of sleeve portions 176a, 176b of a multi-conduit sleeve 176 or assembly 175.

For example, at (L) in FIG. 5B, an interlocking closure strip 283a (e.g., similar to those used on resealable plastic bags) is attached to two adjacent individual sleeve portions 177a,b of a sleeve 176, in such a way as to enable the adjacent individual sleeve portions 177a, 177b to be opened or expanded so as, for example, to accommodate insertion and thereafter secure retention of a one or more conduits 101. For example, by opening the interlocking closure strip 283a, the adjacent sleeve portions 177a, 177b can be opened so as to facilitation insertion of a pair of conduits 101 into the adjacent sleeve portions 177a, 177b. With the conduits in place, as shown for example in FIG. 5A, the interlocking closure strip 283a can be closed by pressing “male” upper portion 283a1 into “female” lower portion 283a2, such that the flexible engagement members of upper portion 283a1 deformably engage corresponding retainers in the lower portion 283a2.

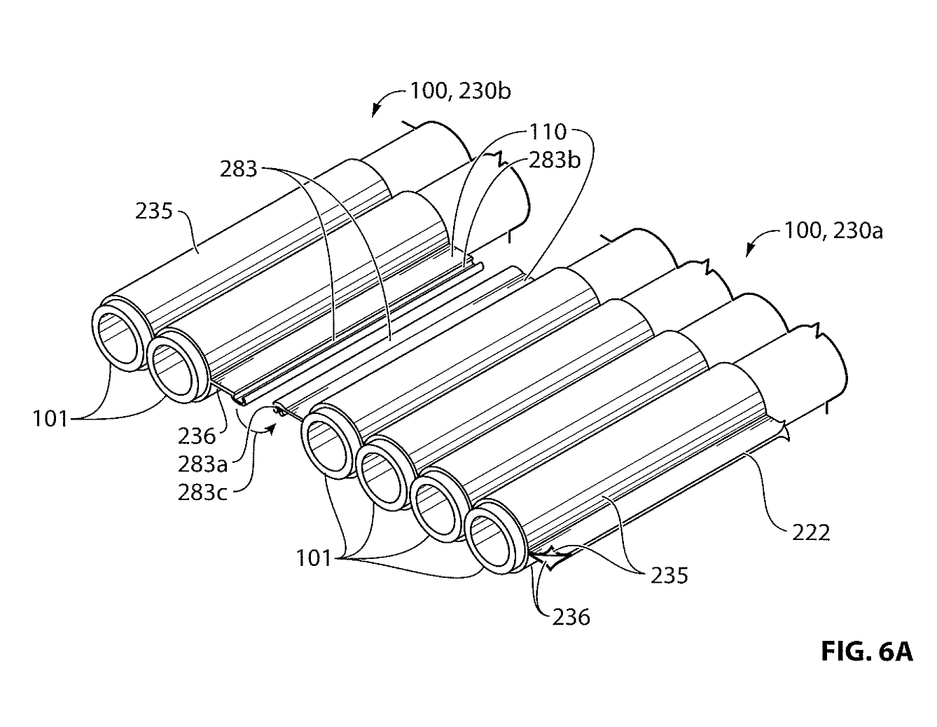

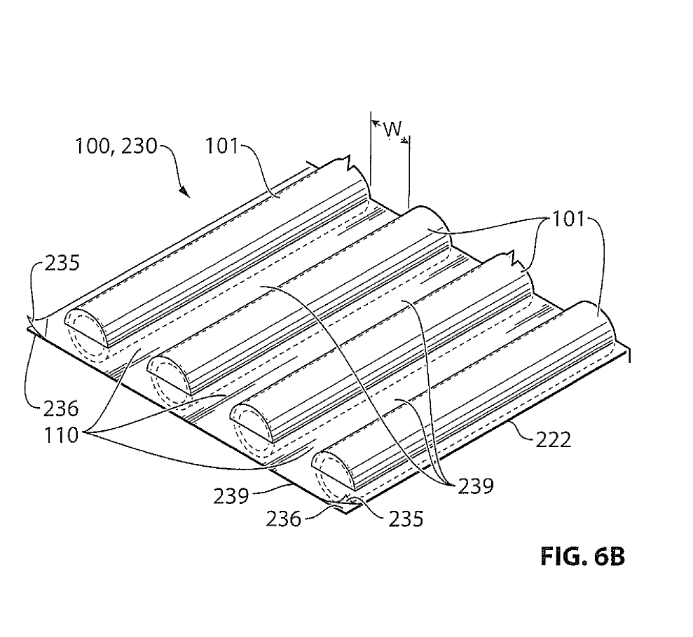

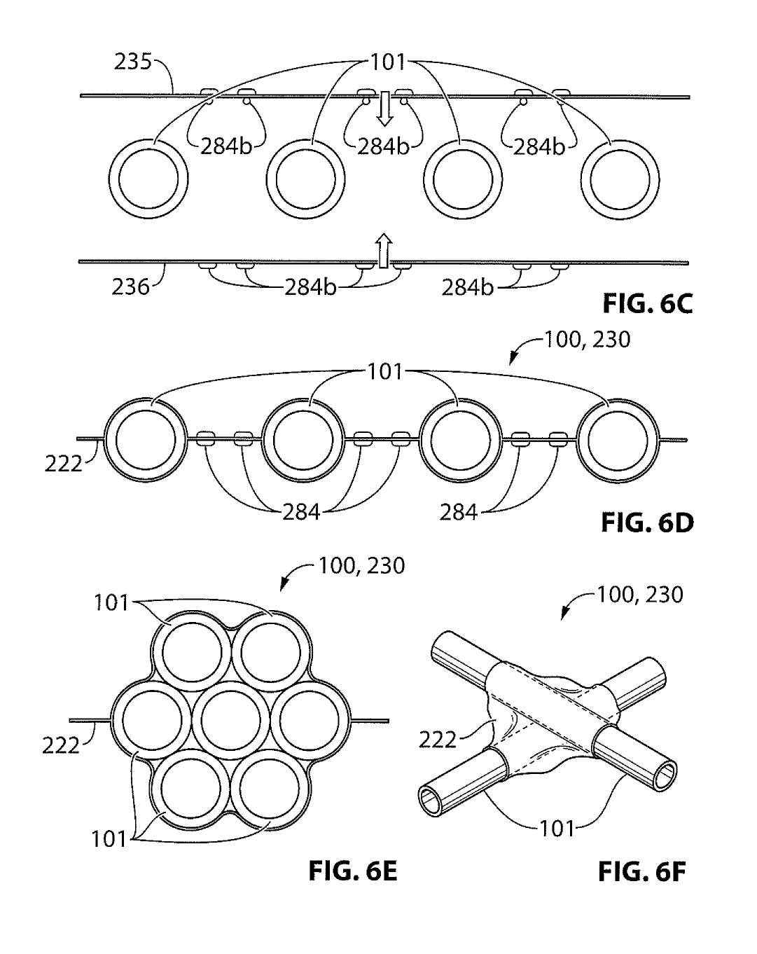

Alternatively, or in addition, as shown at (R) in FIG. 5B (best shown in FIG. 6A), a first multi-sleeve retainer portion 176a can comprise a first, “male” portion of an interlocking closure strip 283b1, while a second multi-sleeve retainer portion comprises a second, corresponding “female” portion 283b2. By alternately engaging the male and female portions 283b1, 283b2, the retainer portions 176a, 176b can be releasable attached to, or detached from, each other, so as to enable the assembly of a multi-conduit assembly 100, 175 having any desired number of individual sleeved conduits 101.

Other forms of permanent and/or releasable attachments that can be used to permananently or reliably secure webs 178 and/or individual sleeves 177 in such manners include snaps 284, zippers (slide interlocking fasteners, not shown), hook and loop fasteners (“Velcro”), and various forms of heat-activated and other adhesives, rivets, etc. A variety of methods of permanently or releasably sealing sleeve joints such as those shown at 4B(L) and 4B(R) are known to those skilled in the relevant arts, and others are disclosed herein. Doubtless other methods will be developed over the course of time.

Thus in various aspects and embodiments the invention provides multi-conduit assemblies 100, each such assembly comprising a plurality of distinct conduits 101, each conduit 101 comprising a length l_{c}; and at least one multi-sleeve retainer 176, each multi-sleeve retainer 176 comprising a plurality of (individual) sleeves 177, each sleeve 177 configured to adapted to enclose at least a portion of the length l_{c} of at least one of the plurality of conduits, whereby the multi-sleeve retainer 176 can retain the plurality of distinct conduits 100 in a desired relative orientation. In the embodiment shown in FIG. 5A, for example, conduits 101 are restrained in a substantially parallel orientation. As will be appreciated by those skilled in the relevant arts, however, sleeves or retainers 176 can be configured to support conduits 101 in any desired parallel and/or non-parallel orientations. As previously noted, such multi-sleeve retainers 176 may be wholly or partly fabricated of electrically-insulating, thermally-insulating, and/or flame-resistant material. In addition, such retainers can be water, liquid, or fluid-proof, hypoallergenic, or comprise any other desired characteristics.

Such multi-sleever retainers 176 can, for example, be fabricated of cross-linked polyethylene, nylon, polyester, other synthetic materials, and/or organic materials such as cotton or linen. Retainers 176 can also be wholly or partially transpartent or transluscent. This can, for example, be especially advantageous where conduits 101 comprised by an assembly 175 are of different colors, where for example the different colors are associated with hot and/or cold water, electrical wires, network, control and fiber-optic cables, etc. For example a hot water conduit can be colored red, a cold water conduit colored blue, and a conduit carrying electrical wiring can be colored black.

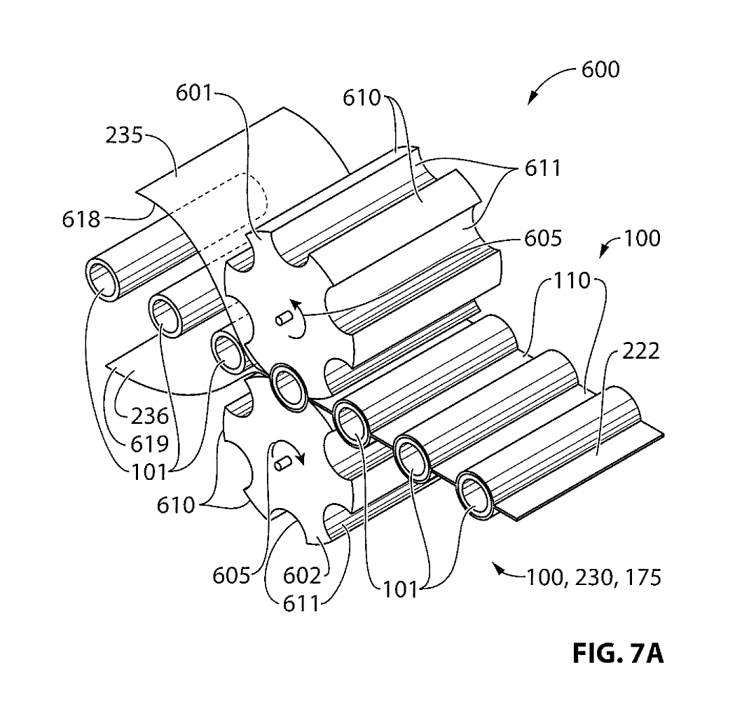

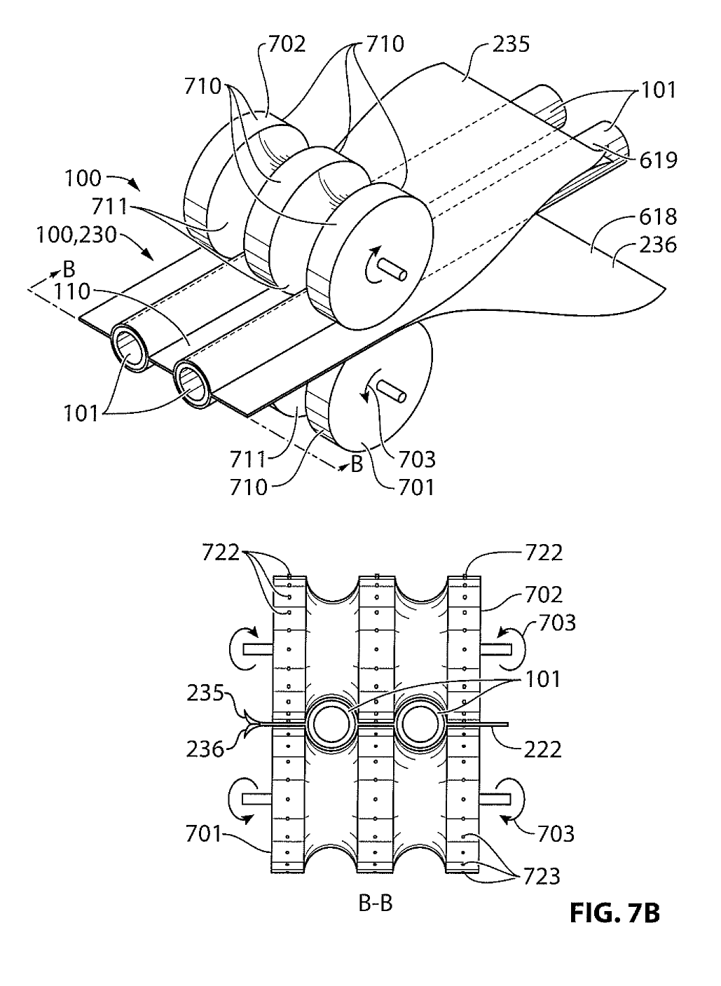

Further embodiments and aspects of the invention are disclosed in connection with FIGS. 6A-7B. Such embodiments and aspects, which may in some respects be considered variations of ‘sleeve’ embodiments shown in FIGS. 5A-5C, comprise the use of plastics or other sheet products to ‘wrap’ and thereby restrain pluralities of conduits 101 in desired orientations. For example, in such embodiments the invention provides multi-conduit assemblies 100, 230, each such assembly comprising a plurality of distinct conduits 101, each conduit being disposed in a desired orientation relative to the remaining at least one conduit of the assembly; and one or more sheets 222, wherein at least a first sheet portion 235 of the one or more sheets 222 is disposed on a first side of the plurality of conduits 101 and at least a second sheet portion 235, 236 of the one or more sheets is disposed on a second side of the plurality of conduits. The at least two sheets portions 235, 236 are at least partially attached to one another, at periphery(ies) 239 and/or webs 110, whereby the plurality of distinct conduits 101 is restrained in the desired orientation.

Multi-conduit assemblies 100, 230 can, for example, be fabricated using single, folded sheets 222, and/or pluralities of distinct sheets. For example, one sheet 222 may be applied to each side of a plurality of conduits 101.

Sheets and/or sheet portions 222, 235, 236 can be fabricated using any materials suitable for the intended purpose(s) of assembly(ies) 100, 230. Suitable sheet materials can, for example, be selected based on the intended use of the assembly 100, 230; the expected environmental and structural conditions of the use, etc. The use of flexible sheets, such as PVC, vinyl, polyethylene (including cross-linked polyethelene), styrene, and other plastics and polymers can be advantageous in a wide variety of applications, particularly where flexibility, transparency, and/or translucency are desired. Thus, in various aspects and embodiments the invention provides multi-conduit assemblies 100, 230, fabricated at least partially of polymers which are flexible at room temperature, and/or within desired temperature ranges, such as greater than or equal to about 50 degrees Fahrenheit below zero.

As in the case of assemblies 100, 175 such as those described above, the use of transluscent (or transparent) sheets can be of particular advantage where, for example, at least two conduits 101 of an assembly 100, 230 are of different colors.

Attachment of sheet portions 235, 236 can be by any suitable and/or otherwise desired means. Factors to be considered in selecting attachment means can include the intended use of an assembly 100, 230; the expected environmental and structural conditions of the use, etc.

For example, as described above in connection with assemblies 100, 175, attachments between individual conduits 101 and/or sets of conduits 101, and optionally formation of web(s) 110, can be accomplished through the use of permanent and/or releasable fasteners, including for example interference-fit fasteners such as interlocking closure strips 283, snaps 284, hook-and-loop fasteners, zippers, etc.

In the example shown in FIG. 6A, an interlocking closure strip 283 is provided for attachment of a first assembly 230a to a second assembly 230b. A ‘male’ portion 283a of the strip 283 is provided on a first web portion 110, and a corresponding ‘female’ portion of the strip is provided on second web portion 110. By aligning the two strip portions 283a, 283b, as shown by arrow 283c, and pressing the two halves together, the male and female portions can flexibly and removably engage one another, and thereby releasably (or removably) secure the two assemblies 230a, 230b together.

In the example shown in FIG. 6C, a plurality of snaps 284 are provided, in pairs, on upper and lower sheets 235, 236, and disposed such that upon being snapped together they will form webs 110, as shown for example in FIG. 6D.

Alternatively, or in addition, assembly(ies) 100, 230 can be formed by the use of adhesive sheets (i.e., sheets 235, 236 wholly or partially coated or otherwise provided with adhesives) on their facing surfaces, such that when the sheets (or sheet portions) 235, 236 are pressed together, they adhere to one another, and/or to conduits 101, in such manner as to form an assembly 100, 230. For example, adhesives can be applied to entireties of mating surfaces of sheet portions 235, 236, and/or it can be applied in strips in locations 239 where webs 110 are to be formed, as shown for example in FIG. 6B.

Alternatively, or in addition, assembly(ies) 100, 230 can be formed through the use of vacuum and/or heat-sealing processes and the like. For example, in FIG. 5B an assembly 100, 230 has been produced by vacuum sealing, such that conduits 101 are not only retained in a desired, generally parallel juxtaposition, but provided with individual fluid-tight sealing. Such fluid-tight sealing can, for example, be used to control formation of rust or other corrosion on interior and/or exterior surfaces of conduits 101 during shipment, storage, and installation.

FIGS. 6E and 6F show further examples of assemblies 100, 230 that can efficiently be produced using vacuum-forming techniques, among others. In the example shown in FIG. 6E, a plurality (7) of conduits 101 has been gathered in a generally hexagonal arrangement, and disposed between sheet portions 235, 236, and a vacuum- and/or heat-sealing process has been applied, with the result that the plurality of conduits 101 has been wrapped together, for further use, for example, as a bundle in installation of conduits in a building or other structure.

Although many of the example embodiments disclosed herein are shown and/or described as being in substantially parallel juxtapositions, the invention both contemplates and enables the effective and efficient production of multi-conduit assemblies of a wide variety of non-parallel juxtapositions. In the example shown in FIG. 6F, for example, a pair of conduits 101 has been placed in a substantially orthogonal disposition and wrapped by a pair of sheet portions 235, 236 through the use of heat-, vacuum- and/or adhesive techniques as described herein. The resulting assembly 100, 230 can be conveniently used for a wide variety of plumbing, electrical, communications, control, cooling, heating, and other applications.

As will be appreciated by those skilled in the relevant arts, once they have been made familiar with this disclosure, any or all of the attachment processes described above—mechanical attachment, adhesives, heat-forming, vacuum forming, etc.—can be used in combination, if and to the extent appropriate. For example, the placement of adhesives on mating surfaces of sheets or sheet portions 235, 236 can enhance the quality and durability of any of the above attachment methods. Moreover, where removable fasteners such as snaps 284, hook-and-loop fasteners (not shown), and interlocking closure strips 283, are employed, removable or releasable (i.e., non-permanent) adhesives can be used with advantage.

As may, for example, be seen by comparison of FIGS. 5C, 6A and 6B, wraps 220, like sleeves or retainers 176, can enclose an entire plurality of conduits 101, or they can engage portions of the circumference of outer surfaces of such conduits in order to restrain the conduits without entirely entirely enclosing them. For example, relatively short lengths of conduits 101 can be engaged by spaced series of multiple wraps 220 as shown in FIG. 5C, so that the conduits are retained in substantially fixed juxtaposition but intermediate lengths of the conduits are freely manipulable.

Example methods of and devices for wrapping pluralities of conduits 101 to form assemblies 100, 230 are described with reference to FIGS. 7A and 7B.

In the example shown in FIG. 7A, a plurality of conduits 101 and sheets or sheet portions 235, 236 are passed through a rotating press assembly 600 comprising toothed-and-grooved press wheels 601, 602 in order to form an assembly 100, 175, 230. By for example passing the components 101, 235, 236 between the press wheels 601, 602 (or by rolling the press wheels over the compenents in the direction of arrows 605), teeth 610 can be caused to engage outer surfaces of the sheets/sheet portions 235, 236 and form web portions 110 by pressing inner sheet surfaces 618, 619 into contact with each other, and thereby engage adhesives; or by applying heat to the outer surfaces of such sheet portions cause the inner portions 618, 619 to adhere to one another. Alternatively, or in addition, grooves 611 can be caused to press the sheet portions 235, 236 into engagement with outer surfaces of individual conduits 101 and thereby cause the sheet portions 235, 236 to adhere to the outer surfaces of the conduits 101.

By applying heat to the sheets 235 and/or 236 by means of heating any or all of teeth 610, grooves 611, of either or both of press wheels 601, 602, the press 600 can cause inner surfaces 618, 619 of the sheets/sheet portions 235, 236 to adhere to all or any portion(s) of each other and/or conduits 101. Alternatively, or in addition, inner surfaces 618, 619 can be wholly or partially coated with adhesives such that teeth 610 and/or grooves 611 cause inner surfaces 618, 619 of the sheets/sheet portions 235, 236 to adhere to all or any portion(s) of each other and/or conduits 101.

In the example shown in FIG. 7B, a plurality of conduits 101 and sheets or sheet portions 235, 236 are passed through a rotating press assembly 700 comprising flanged-and-grooved press wheels 701, 702 in order to form an assembly 100, 175, 230. By for example passing the components 101, 235, 236 between the press wheels 701, 702 (or by rolling the press wheels over the compenents in the direction of arrows 703), grooves grooves 611 can engage outer surfaces of the sheets/sheet portions 235, 236 and press them into engagement with outer surfaces of individual conduits 101, and/or flanges 710 can press inner surfaces 618, 619 into contact with each other to form webs 110. By applying heat to the sheets 235 and/or 236 by means of heating any or all of flanges 710 and grooves 711, of either or both of press wheels 701, 702, the press 700 can cause inner surfaces 618, 619 of the sheets/sheet portions 235, 236 to adhere to all or any portion(s) of each other and/or conduits 101. Alternatively, or in addition, inner surfaces 618, 619 can be wholly or partially coated with adhesives such that flanges 710 and/or grooves 711 cause inner surfaces 618, 619 of the sheets/sheet portions 235, 236 to adhere to all or any portion(s) of each other and/or conduits 101.

As shown in view B-B of FIG. 6B, presses 600, 700 can be used to provide perforations 120 in webs 110. For example, teeth 722 of desired size and configuration can be provided, at desired spacing(s), on outer surfaces of flanges 710 of wheels 702, so that as sheets 235, 236 pass between the press wheels 701, 702, the teeth engage corresponding recesses, which may for example be correspondingly-sized, shaped, and spaced indentations, or for example grooves) perforations 120 are punched at desired intervals into the web(s) 110.

As will be understood by those skilled in the relevant arts, once they have been made familiar with this disclosure, suitably-configured presses 600, 700 (including particularly teeth 610, flanges 710) can be used to install and/or close permanent or releasable mechanical fasteners, such as rivets, interlocking strip fasteners 283, snaps 284, hook-and-loop fasteners, etc. in webs 110 or along the edges of assemblies 100, 175, 230. Presses 600, 700 etc. can also be used in conjunction with vacuum-sealing and other processes, as explained above.

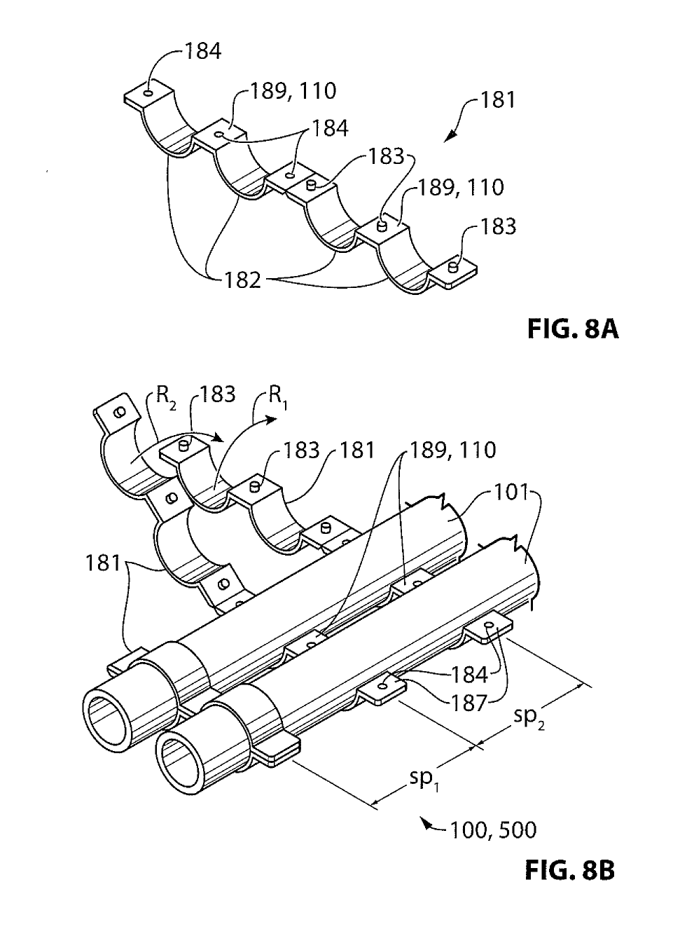

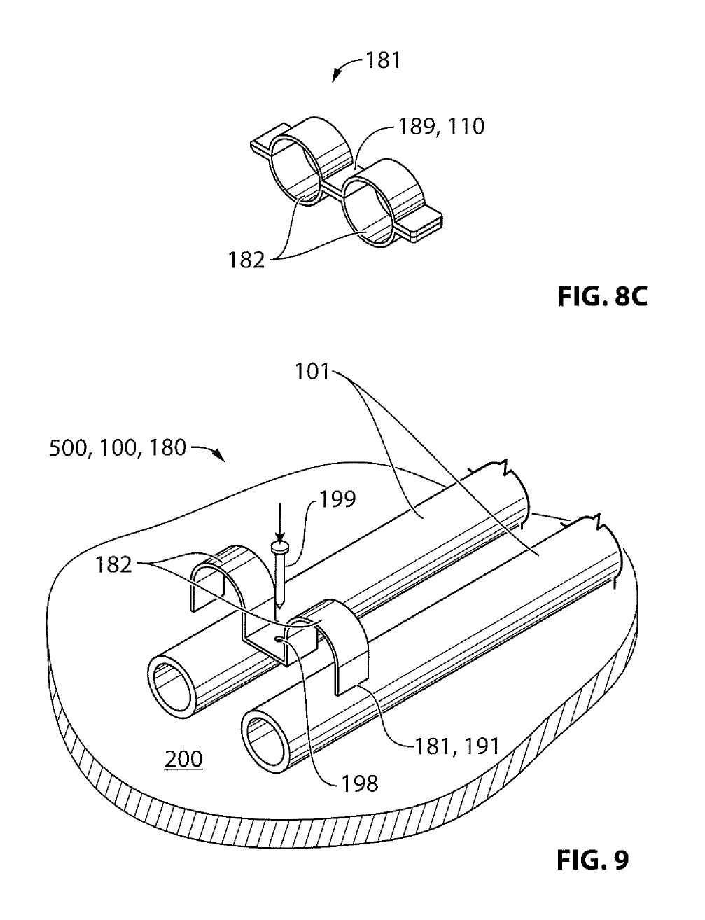

As shown for example in FIGS. 8A-10, multi-conduit assemblies 100 in accordance with the invention can also be formed by use of one or more relatively or substantially rigid conduit retainers or clips 181 to physically restrain a plurality of conduits 101 in a desired juxtaposition by being placed next to, around, or upon the conduits. Such clips or retainers can be used alone, or in combination with other devices and methods disclosed herein. As shown for example in FIG. 8B, a plurality of retainers 181 can be placed upon a plurality of conduits 101 and fixed at various spacings Sₚ along the lengths l_{c} of the conduits, and thereafter fixed around the conduits, permanently or removably, through the use of adhesives, mechanical clasps and/or fasteners, etc. The resulting conduit assembly 500 can thereafter be installed in any desired location and used for its intended purpose(s).

A retainer 181 can comprise one or more individual conduit retainer portions 182, each of which can be adapted to engage all or any portion(s) of a circumference, periphery, or other external portion of a surface of a conduit 101; for example as explained and shown with reference to FIGS. 5B and 6B, individual conduit retainer portions 182 can be curved with radii adapted to engage outer surfaces of conduits 101 with any desired degree of closeness or play. After having been placed in a desired relationship to the conduits 101, an open portion 186 can be rotated in the direction of arrows R1, R2 so as to close over remaining exposed portion(s) of the conduits 101 and optionally to engage engaged portions 187 of the retainers 181, and thereby retain the conduits 101 in a desired juxtaposition defined by the retainer portions 182 and webs 189, 110 (if any).

Closeable retainer(s) 181 such as that shown in FIGS. 7A-7C can be held in a closed position such as that shown in FIG. 5C permanently or non-permanently. For example, retainer(s) 181 can be closed permanently or temporarily with adhesive, or they can be retained permanently or releasably by means of pins 183 and detents 184, as for example through the use interference fits, snaps, clasps, etc.

FIG. 9 shows another embodiment 191 of a retainer 181. In the embodiment shown, web 189 of retainer 191 comprises a fastener hole 198 adapted to accommodate a nail, screw, staple, or other fastener 199. In use, one or more retainers 181, 191 can be placed along lengths “l” of a plurality of conduits 191, for example at one or more spacings Sp as shown in FIG. 5B. Portions 182 of retainers 181, 191 can be used to trap conduits 101 against a wall or other structure or support 200, and one or more fasteners 199 can be installed to permanently or releasably hold the retainer 181, 191, and thereby retain conduits 101, in desired juxtaposition relative to one another and the support 200.

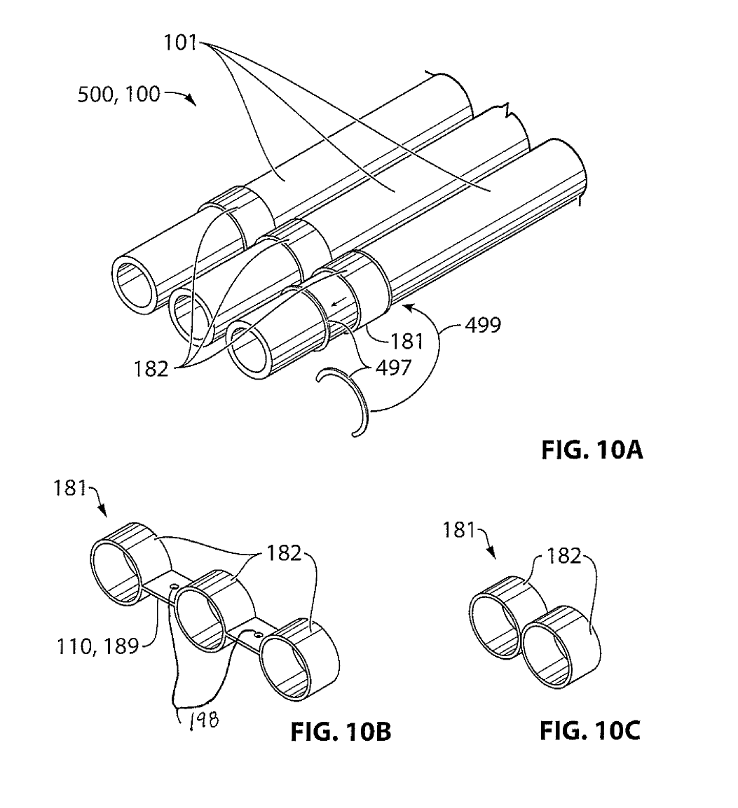

In the embodiments shown in FIG. 10, retainers 181 comprise individual retainer portions 182 adapted to entirely enclose individual conduits 101. Such retainers can, for example, be installed at desired intervals by inserting one or more conduits 101 and sliding the retainers along the lengths l_{c} of the conduit(s) until they are in the desired location. Once in a desired position, a retainer 191 according to such embodiments can optionally be glued, welded, adhered, or otherwise held in place by, for example, the use of flexible lock washer(s) or clips 497. As shown by arrow 498, for example, a first such flexible clip can be flexed open and installed in a desired location, whereupon a retainer 181 can be slid into place next to it, while a second clip 497 is flexed and installed behind the retainer 181 to hold the retainer in the desired location. A plurality of retainers 181 can be installed at desired spacings in such fashion, and an assembly 100 can be installed as desired. As with other clip embodiments, such clips 181 can be provided with webs 110, 189, and/or holes or other features for accommodating nails, screws, and/or other fasteners.

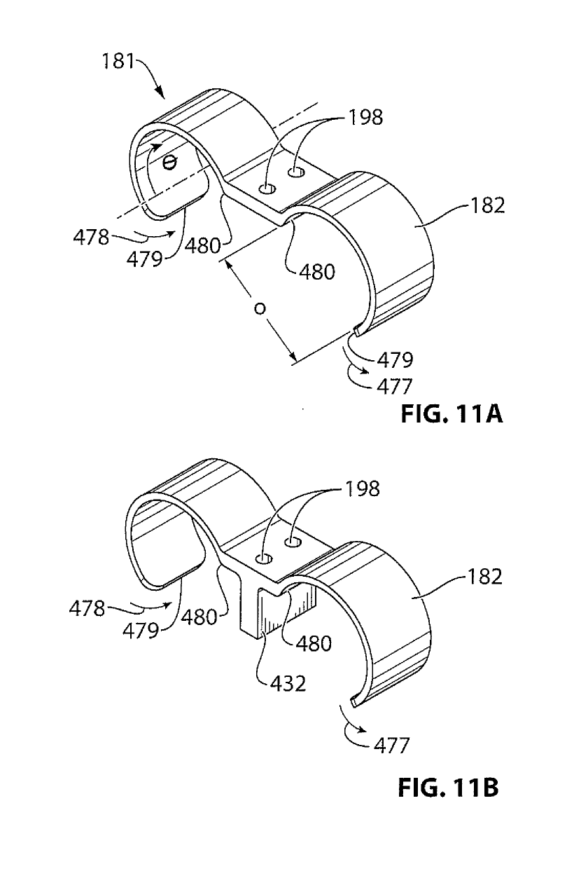

In the embodiments shown in FIG. 11, clips or retainers 181 comprise flexible retainer portions 182 adapted to flex outward (toward a more open shape) in the direction of arrows 477 in order to accommodate placement around the peripheries of conduits 101, and then to flex back into substantially their original configurations, in the direction of arrows 478, and thereby clasp or otherwise retain a plurality of conduits 101 in a desired juxtaposition with respect to one another. Means of ensuring that such functionality is possible include (a) ensuring that an angle 0, measured around the central axis C-C of the individual clip portion 182 (i.e., generally coincident with the longitudinal axis of a conduit retained by the clip portion 182) and between a tip 479 of the clip to the clip's baseline 480 is greater than about 180 degrees; and/or to ensure that a distance “O” measure from the tip of the clip 479 to its baseline 480 is less than the outside diameter of a conduit 101 to be retained by the clip. As will be readily understood, the exact dimensions of angle θ and/or distance “O” will depend on factors such as the material the retainer clip 181 is made of, the thickness tᵣ, the outside diameter of the conduit 101 to be retained by the clip, and the materials used to make the conduit 101, etc. As with other clip embodiments, such clips 181 can be provided with webs 110, 189, and/or holes or other features for accommodating nails, screws, and/or other fasteners.

In FIG. 11B, web 110 comprises a rib or separator 432 configured to cooperate with flange(s) or retainer portions 479 in holding conduits in a desired juxtaposition, and/or for separating adjacent conduits 101. In addition, rib(s) or separator(s) 432 can comprise holes 198 for fasteners, etc., as described above.

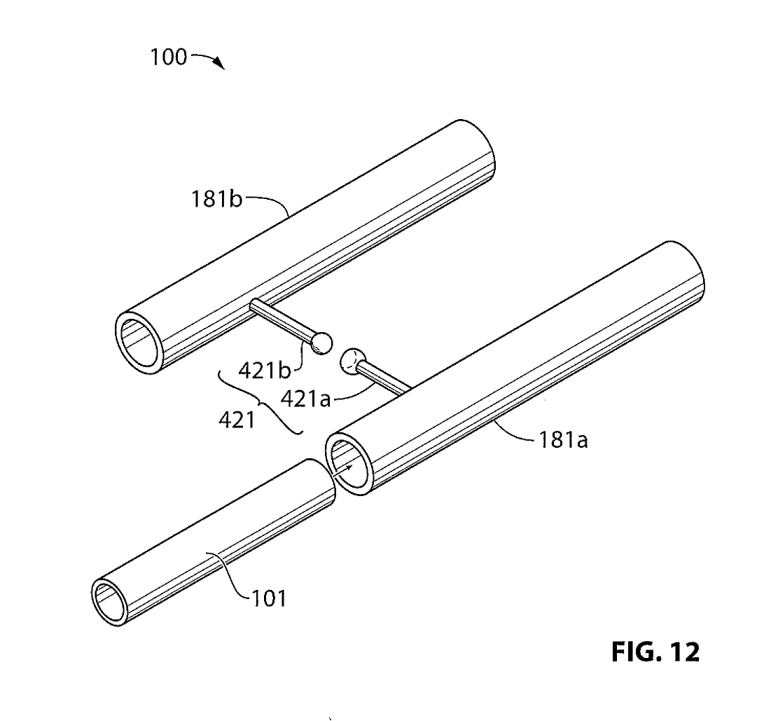

FIG. 12 shows a further variation of retainers 181. In the embodiment shown, a mating pair of retainers 181a, 181b comprise male and female retainer devices 421a and 421b. In the embodiment shown, the retainer device 421 comprises a ball 421b component and a socket 421 component. As will be readily understood by those skilled in the relevant arts, a very wide variety of mating retainers, many of which will comprise interference-fit devices such as ball-and-socket device 421, can be provided. In use, an individual conduit 101 can be inserted into each of the retainers 181a, 181b, either before or after the mating retainers 421a, 421b are coupled. Coupling of devices 421a, 421b can take place either before or after installation of the conduits 101. Advantages provided by the use of mating retainers 181a, 181b include the ability to uncouple individual retainer(s) following installation of an assembly 100, for example to remove or otherwise manipulate individual conduits 101 or sections thereof.

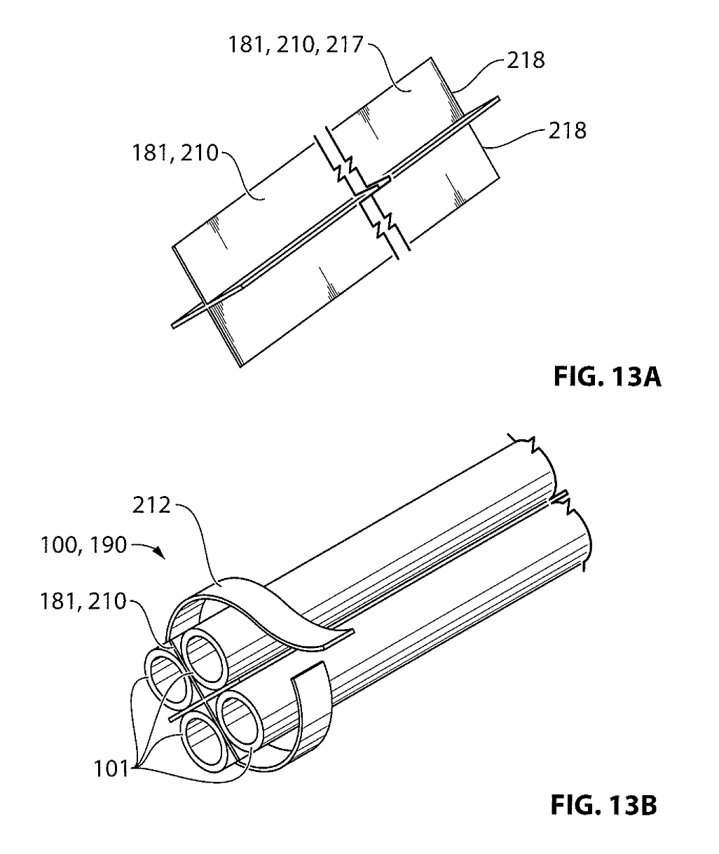

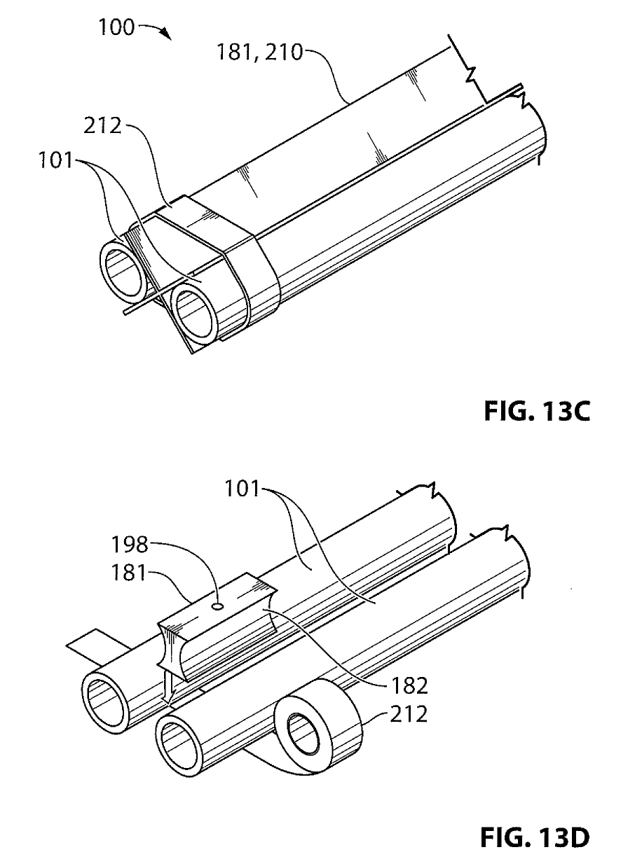

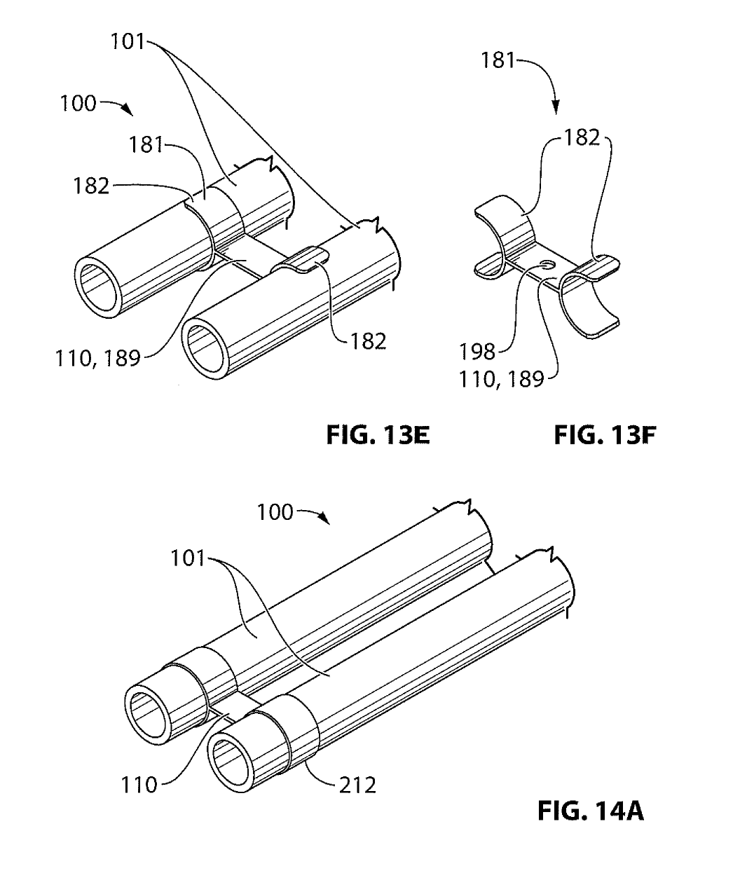

Further alternatives for forming multi-conduit assemblies 100 in accordance with the invention are shown in FIGS. 13A-13E. In such embodiments one or more spacer-retainers 181, 210 can be placed at desired spacings Sₚ (as shown for example in FIG. 7B) between or amongst a plurality of conduits 101, and wrapped with tape, elastic bands, plastic sheet or ribbon, natural or synthetic fabrics, Velcro or other flexible, preferably adherent sheet material 212 so as to hold the conduits in a desired juxtaposition in relation to one another, and thereafter fastened to a wall or other support 200 using one or more fasteners 199 and optionally further retainer(s) 181 of the same or other types.

In the embodiment shown in FIGS. 13A-13C, a cruciform spacer-retainer 217 can accommodate between one and four individual conduits 101. Once the desired number of conduits are in place between flanges 218 of the spacer-retainer 217, tape, elastic bands or straps, or other wrap(s) 212 can be placed around it to secure them.

In the embodiments shown in FIGS. 13D and 13E, retainer portions 182 of spacer-retainers 181, which do not comprise sufficient radial or circumferential length or curvature to clasp or otherwise retain a conduit 101, can be used advantageously with tape or other wraps 212, and particularly adhesive or cohesive wraps, to engage and restrain conduits 101 in desired juxtaposition(s). In such embodiments a desired juxtaposition can be maintained by using wrap 212 to hold the conduits securely against retainer faces or portions 182, the faces or portions 182 being configured to engage a portion of an outer surface or periphery of conduits 101 when the conduits are in the desired juxtaposition. As shown for example in FIG. 13E, such spacer-retainer embodiments can comprise web portions 110, 189 which can be relatively or substantially rigid in order for example to maintain a desired separation between adjacent conduits 110; and which in turn can include one or more fastener holes 198 for facilitating securement of the retainer to wall or other support structure 200.

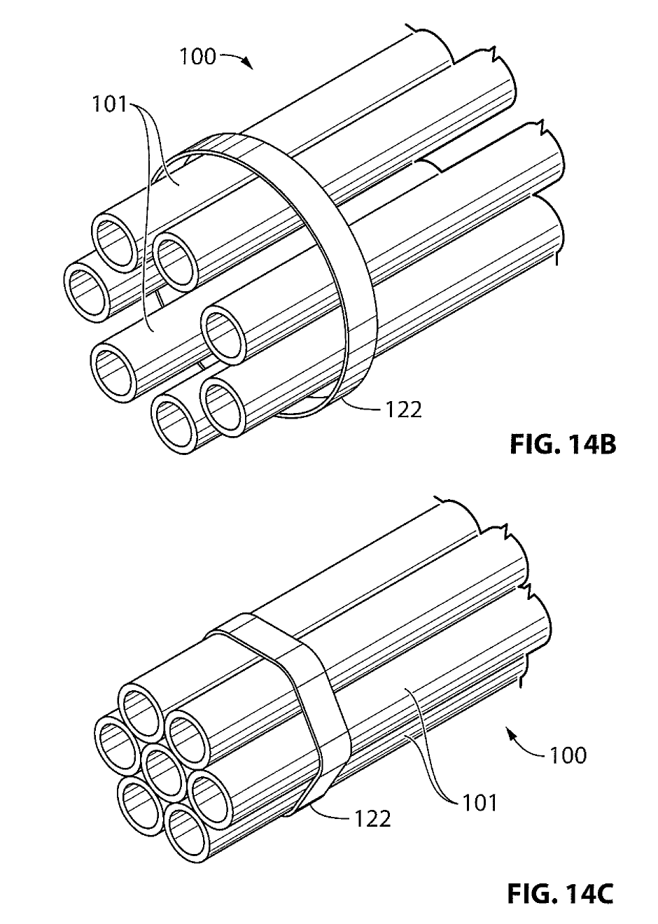

FIGS. 14A-14C show embodiments of assemblies 100 formed solely of pluralities of conduits 101 and tape or other wraps, which may be any or all of adhesive, cohesive, and elastic. Such embodiments can, for example, be fabricated using suitably-configured strips of nylon or other polymers, fitted with hook-and-loop fasteners, rivets, snaps, etc., as described above, and they can be used advantageously alone, or in combination with other features, including for example retainers 181, 182 as shown in FIGS. 8 and 9.

In the embodiment shown in FIG. 14A, cohesive and/or adhesive tape or other wrap 212 is used both to securely retain a plurality of conduits 101 in a desired juxtaposition by engaging all at least substantial portions of external surfaces or peripheries of the conduits, and to form a web 110 by means of self-adherence between the conduits. Again, such embodiments can alternatively be fabricated using suitably-configured strips of nylon or other polymers, fitted with hook-and-loop fasteners, rivets, snaps, etc., as described above.

As will be readily appreciated by those skilled in the relevant arts, a very wide variety of further configurations for spacer-retainers 181, 210 can be used with advantage, depending upon the number of conduits 101 to be retained, the manner and environment in which they are to be installed, etc.

Clips or retainers 181, 210 in accordance with the invention can be wholly or partially fabricated using any suitable material(s), including for example plastics and other polymers, metals, carbon- and/or glass fibers, wood or wood products, etc., and various structural composites. As will be understood by those skilled in the relevant arts, once they have been made familiar with this disclosure, identification of suitable material(s) can depend on a number of factors, including intended use(s) of the retainers, intended use(s) of assemblies 100 comprising the retainers, environmental and other conditions under in which the retainers are to be used, etc. As a specific example, clips or retainers 181, 210 intended for various uses in home construction, renovation, or repair can be fabricated by the use of plastic or other polymers. Clips or retainers intended for use with large concrete, metal, or PEX conduits, such as drainage or sewer pipes, or other conduits intended for underground use, can be fabricated using metals, fiber-carbon composites, and/or heavy duty polyers, etc.

As noted above, by being fabricated using relatively or substantially rigid materials such as hard plastic, metal, or fiber-reinforced composites, such clips or retainers 181, 210, and any incorporated web portions 110, 189, can effectively restrain conduits 101 at desired spacings from one another, and in desired juxtapositions. Optionally, retainer portions 182 of such retainers can be made of the same and/or other materials as webs 110, 189, and other portions of the clips or retainers 181. In addition, surfaces 182 of retainers 181 intended for contact with conduit(s) 101 can be coated with or otherwise include adherent or anti-corrosive materials, and/or materials having other desired or desirable properties.

Wraps 212 in accordance with the invention can be fabricated using any suitable material(s), including for example plastics and other polymers, natural and synthetic fabrics such as cotton, nylon, or polyester, etc. As will be understood by those skilled in the relevant arts, once they have been made familiar with this disclosure, identification of suitable material(s) can depend on a number of factors, including intended use(s) of the wraps, intended use(s) of assemblies 100 comprising the wraps, environmental and other conditions under in which the wraps are to be used, etc. Optionally, wraps 212 can comprise adherent or coherent surfaces. As noted above, single- or double-sided pressure-sensitive tapes, sometimes known as cellotape, PSA tape, adhesive tape, or self-stick tape, and which adhere to surfaces with application pressure and without the need for solvents or heat for activation, can be of significant advantage when used with various aspect and embodiments, including for example the embodiments shown in any of FIG. 5, 6, or 12-13. Single-sided tapes enable bonding to a surface or joining of two adjacent or overlapping materials. Double-sided tape (adhesive on both sides) allows joining of two items back-to-back. Double-sided tape can, for example, be used with particular advantage as whole or partial coatings for surfaces of retainer portions 182 that are intended for contact with external surfaces of conduits 101. Hook-and-loop fasteners, snaps, interlocking strips, and other mechanical fasteners can also be used with advantage in various applications.

As previously noted, conduit(s) 101 suitable for use in implementing various aspects and embodiments of the invention can be fabricated of electrically, thermally, or otherwise-insulating material(s), in order to enhance the safety and effectiveness of their uses. As will further be appreciated by those skilled in the relevant arts, dimensions of assemblies 100, conduits 101, webs 110, and other devices and components in accordance with the invention can vary in accordance with their intended use, etc. As a specific example, an embodiment of an assembly 100 configured for use in transferring water can be fabricated using PEX, and can comprise a plurality of conduits 101 and one or more webs 110 having the following overall dimensions:

l_{c} (overall length)=as desired; indefinite, coiled or straight

dₒ (conduit outside diameter)=approx. 0.075 to approx. 24 inches, or more

dₒ-dᵢ (conduit thickness)=approx. 0.020 to approx. 3.00 inches

t_{w} (web thickness)=approx. 0.020 to approx. 6 inches

s (web width; spacing between conduits)=approx. 0.020 to approx. 10 inches

Moreover, as previously mentioned, individual conduits 101, 102, 104, etc. of a multi-conduit assembly 100 can be of differing dimensions. For example, in an embodiment intended for transfer of gasses and/or liquids in a heating or cooling application, a delivery line may be of approximately 1 inch inside diameter, while a return line may be smaller, for example about ½ inch inside diameter. Applying principles disclosed herein, it will be understood that such multi-conduit pipes may be commonly extruded or otherwise commonly formed in any of a very wide variety of differing inside and outside diameters.

As previously noted, individual conduits 101 of a multi-conduit assembly 100 may be of any one or more desired cross-sections, including for example circular, elliptical, or rectangular, and of any desired length(s).

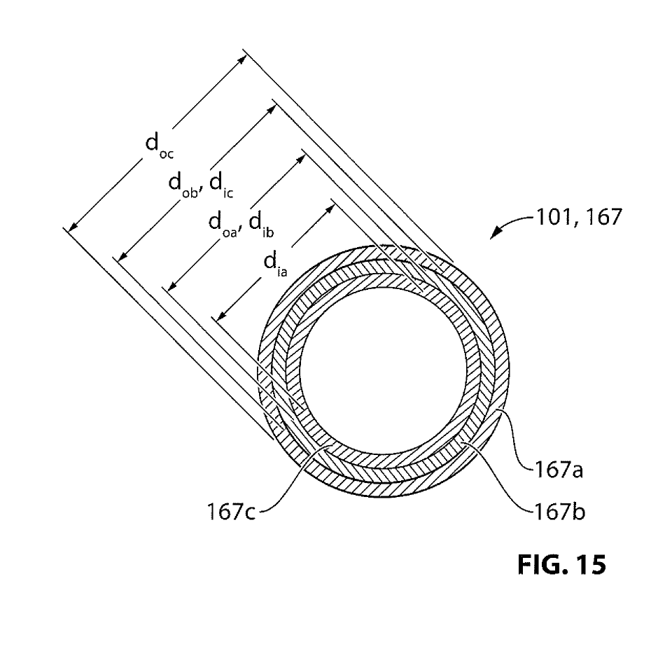

In various embodiments, one or more individual conduits 101, 167 of a multi-conduit assembly 100 in accordance with the invention can comprise multi-layered walls, as shown for example in FIGS. 5A and 15. For example, a PEX pipe 101 can comprise multiple co-extruded wall layers 101a, 167a; 101b, 167b, of desired thicknesses. Likewise, multi-walled pipes 101, 167 can comprise inner and outer walls of varying materials; for example an inner conduit 101a can be fabricated using PEX, and an outer layer 101b can be of steel. As will be understood by those skilled in the relevant arts, any desired number of walls or layers 101a, 101b, etc., can be used. Multi-layer conduits 101 can be fabricated using co-extrusion techniques, multiple sequential extrusion processes, and/or one or more inner conduits 101a, 167a can be inserted within a desired outer conduit 101b, 167b. They may also be fabricated using relatively stronger or reinforced materials (such as plastics comprising embedded carbon or metal fibers) to increase strength while remaining flexible. For example, co-extruded and/or other types of multi-layer conduits 101 can be provided, in order to provide tailored or otherwise desired combinations of characteristics or qualities. For example, as shown in FIG. 15, a multi-layered conduit 101, 167 can comprise a plurality (in the embodiment shown, three) of concentric layers 167a, 167b, 167c, etc., which can be commonly molded, drawn, extruded, or otherwise formed. An inside layer 167c, having a inside diameter dᵢₐ and an outside diameter dₒₐ, can comprise any desired characteristics, such as corrosion resistance. A second layer 167b, having a inside diameter d_{ib} and an outside diameter d_{ob}, can comprise the same or any additional or alternative characteristics, including for example thermal insulation. A third or subsequent layer 167c, etc., having a inside diameter d_{ic} and an outside diameter d_{oc}, can comprise any further or alternative desired qualities, such as electrical insulation. As will be understood by those skilled in the relevant arts, fine control of inside diameters dᵢₓ and outside diameters dₒₓ, can be used to control the ease within which inner conduits may removed from outer conduits, flexibility of a composite conduit 167, etc.

Thus, among other improvements, multi-line conduits 100 in accordance with the invention provide assemblies 100 in which at least two of the conduits are fabricated to have different cross-sectional shapes, sizes (e.g. length, inside and/or outside diameter), colors, and mechanical, electrical, thermal, and/or other physical characteristics.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

Selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A multi-conduit assembly comprising a plurality of distinct conduits, at least two of the plurality of conduits joined by at least one web.

2. The multi-conduit assembly of claim 1, wherein at least one of the distinct conduits is fluid tight and the conduits and the at least one web are formed as a single, continuous extrusion.

3. The multi-conduit assembly of claim 1, comprising a plurality of distinct, fluid-tight conduits.

4. The multi-conduit assembly of claim 3, comprising at least three distinct, fluid-tight conduits.

5. The multi-conduit assembly of claim 3, wherein the at least two of the distinct, fluid-tight conduits are joined by a plurality of webs.

6. The multi-conduit assembly of claim 1, wherein the at least one web is frangible, such that the distinct, fluid-tight conduits may be separated one from another without compromising their fluid tight integrity.

7. The multi-conduit assembly of claim 6, wherein the at least one frangible web comprises a plurality of perforations.

8. The multi-conduit assembly of claim 3, wherein the plurality of distinct, fluid-tight conduits is fabricated using material suitable for transfer of at least one of water, hydraulic fluid, and glycol.

9. The multi-conduit assembly of claim 1, wherein the plurality of distinct conduits is at least partially fabricated of electrically-insulating material.

10. The multi-conduit assembly of claim 1, wherein the plurality of distinct conduits is at least partially fabricated of thermally-insulating material.

11. The multi-conduit assembly of claim 1, fabricated at least partially of a polymer which is flexible at room temperature.

12. The assembly of claim 11, wherein the polymer comprises cross-linked polyethylene.

13. The multi-conduit assembly of claim 1, wherein at least two of the conduits are of different color.

14. The multi-conduit assembly of claim 1, wherein at least two of the conduits are fabricated to have different cross-sectional shapes.

15. The multi-conduit assembly of claim 1, wherein at least two of the conduits are of different inside diameter.

16. The multi-conduit assembly of claim 1, wherein at least one of the conduits comprises at least a first layer fabricated of a first material, and a second layer fabricated of a second material.

17. The multi-conduit assembly of claim 1, wherein the first layer is an inner layer and the first material is corrosion resistant.

18. The multi-conduit assembly of claim 1, wherein the first layer is an inner layer and the first material is electrically insulating.

19. The multi-conduit assembly of claim 1, wherein the second layer is an outer layer and the second material is fire resistant.

20. A multi-conduit assembly comprising:
a plurality of distinct conduits, each conduit being disposed in a desired orientation relative to the remaining at least one conduit of the assembly; and
one or more sheets, wherein at least a first sheet portion of the one or more sheets is disposed on a first side of the plurality of conduits and at least a second sheet portion of the one or more sheets is disposed on a second side of the plurality of conduits, the at least two sheets portions being at least partially attached to one another, whereby the plurality of distinct conduits is restrained in the desired orientation.

21. The multi-conduit assembly of claim 20, wherein at least one of the distinct conduits is fluid tight.

22. The multi-conduit assembly of claim 20, comprising a plurality of distinct fluid-tight conduits.

23. The multi-conduit assembly of claim 22, comprising at least three distinct, fluid-tight conduits.

24. The multi-conduit assembly of claim 20, wherein the plurality of distinct, fluid-tight conduits is fabricated using material suitable for transfer of at least one of water, hydraulic fluid, and glycol.

25. The multi-conduit assembly of claim 20, wherein at least one of the sheet portions is at least partially fabricated of electrically-insulating material.

26. The multi-conduit assembly of claim 20, wherein at least one of the sheet portions is at least partially fabricated of thermally-insulating material.

27. The multi-conduit assembly of claim 20, wherein at least one of the sheet portions is at least partially fabricated of flame-resistant material.

28. The multi-conduit assembly of claim 20, fabricated at least partially of a polymer which is flexible at room temperature.

29. The multi-conduit assembly of claim 28, wherein the polymer comprises cross-linked polyethylene.

30. The multi-conduit assembly of claim 20, wherein at least two of the conduits are of different colors and at least a portion of the one or more sheets is transluscent.

31. The multi-conduit assembly of claim 20, wherein the attachment is by means of one or more interference-fit fasteners.

32. The multi-conduit assembly of claim 31, wherein the one or more interference-fit fasteners comprises at least one interlocking closure strip.

33. The multi-conduit assembly of claim 20, wherein the attachment is by means of heat-activated adherence.

34. The multi-conduit assembly of claim 20, wherein the attachment is by means of one or more mechanical fasteners.

35. The multi-conduit assembly of claim 20, wherein the restraint is at least partially caused by a shrink-wrap process.

36. The multi-conduit assembly of claim 20, comprising a plurality of sheets, each of the sheets comprising a length Is that is less than one half of a length lc of at least one of the conduits.

37. A multi-conduit assembly comprising a plurality of distinct conduits held in a desired juxtaposition by one or more retainers.

38. The multi-conduit assembly of claim 37, wherein at least one of retainers is placed between a pair of adjacent conduits.

39. The multi-conduit assembly of claim 37, comprising at least one wrap disposed to at least partially encircle at least two of the conduits conduits.

40. The multi-conduit assembly of claim 37, wherein the one or more retainers comprise at least one clip.

41. The multi-conduit assembly of claim 40, wherein the at least one clip comprises a closure member.

42. The multi-conduit assembly of claim 41, wherein the closure member is configured to retained in a closed position whereby at least a plurality of the conduits is retained in the desired juxtaposition by an interference mechanism.

43. The multi-conduit assembly of 42, wherein the closure member is configured to close permanently around the plurality of conduits.

44. The multi-conduit assembly of claim 42, wherein the closure member is configured to close releasably around the plurality of conduits.

45. The multi-conduit assembly of claim 41, wherein the at least one clip is flexible, and configured to retain at least a plurality of the conduits in the desired juxtaposition by flexible engagement of at least a portion of a circumference of the plurality of conduits.

46. The multi-conduit assembly of claim 37, wherein the retainer comprises a web configured for attachment of the retainer to a support structure by means of a fastener.

47. A multi-conduit assembly comprising:
a plurality of distinct conduits, each conduit comprising a length lc; and
at least one multi-sleeve retainer, each multi-sleeve retainer comprising a plurality of sleeves, each sleeve configured to adapted to enclose at least a portion of the length lc of at least one of the plurality of conduits,
whereby the multi-sleeve retainer retains the plurality of distinct conduits in a desired relative orientation.

48. The multi-conduit assembly of claim 47, wherein the multi-sleeve retainer is flexible.

49. The multi-conduit assembly of claim 47, wherein at least a portion of the multi-sleeve retainer is fabricated of electrically-insulating material.

50. The multi-conduit assembly of claim 47, wherein at least a portion of the multi-sleeve retainer is fabricated of thermally-insulating material.

51. The multi-conduit assembly of claim 47, wherein at least a portion of the multi-sleeve retainer is fabricated of flame-resistant material.

52. The multi-conduit assembly of claim 47, wherein at least a portion of the multi-sleever retainer is fabricated of cross-linked polyethylene.

53. The multi-conduit assembly of claim 47, wherein at least a portion of the multi-sleever retainer is transluscent.

54. A multi-conduit assembly comprising a plurality of conduits joined to one another along at least a portion of their lengths, in a substantially parallel juxtaposition.
